(19) United States
(12) Patent Application Publication
(10) Pub. No.: US 2011/0068194 A1
(43) Pub. Date: Mar. 24, 2011

(54) COOLING STRUCTURE OF FUEL INJECTION VALVE

(75) Inventor: Taro Tsukamoto, Kanagawa (JP)

(73) Assignee: MITSUBISHI HEAVY INDUSTRIES, LTD., Tokyo (JP)

(21) Appl. No.: 12/991,971

(22) PCT Filed: Sep. 17, 2009
(86) PCT No.: PCT/JP2009/066267

§ 371 Date: Nov. 23, 2010

(30) Foreign Application Priority Data
Dec. 11, 2008 (JP) 2008-315393

(51) Int. Cl. B05B 15/00

(52) U.S. Cl. 239/132.3

(57) ABSTRACT

The present invention provides a cooling structure of a fuel injection valve that can cope with the high load operation of the engine by efficiently transferring heat from a nozzle to a cylinder head, thereby improving the cooling efficiency of the injection valve including the nozzle valve. In the cooling structure, fuel is injected through an injection hole by opening and closing of the needle valve 2 that is reciprocatably fit inside the nozzle and removably attached to a seating portion of the nozzle at a tip. The cooling structure comprises a metal ring member 10 which is interposed between an outer circumferential face of the nozzle nut 3 and an inner circumferential face of the outer sleeve 6 so as to transfer heat from the nozzle 1 to the cylinder head 110 via the nozzle nut 3 and the outer sleeve 6.

### BACKGROUND OF THE INVENTION

1. Field of the Invention

The present invention mainly relates to a cooling structure of a fuel injection valve to be applied to a diesel engine.

2. Description of the Related Art

FIG. 4 is a sectional view of a relevant part of a conventional fuel injection valve of a diesel engine.

FIG. 4 shows a fuel injection valve 100 in which a nozzle has an injection hole for injecting fuel at a tip thereof and a needle valve 2 is fit in the nozzle 1 such that the valve can reciprocate therein. When there is no injection, the tip of the needle valve 2 is in contact with a seating portion of the nozzle 1 so as to store high-pressure fuel in a fuel storage 5.

A fuel injection valve body 16 includes a hollow space 16a and a spring shoe 8a of the nozzle valve is fit in the hollow space at a bottom thereof in such a manner that the spring shoe 8a is in contact with a top end 2a of the needle valve 2.

Further, a needle valve spring 9 is interposed in the hollow space 16a between the spring shoe 8a and the injection valve body 16. In the non-injection state, the needle valve spring 9 presses the tip of the needle valve 2 against the seating portion 5a of the nozzle 1.

Furthermore, a spacer 15 is interposed between the injection valve body 16 and the nozzle 1. The needle valve 2 is inserted into the spacer 15. A fuel passage 21 is in connective communication with the fuel storage 5 through the injection valve body 16, the spacer 15 and the nozzle 1.

The top of the injection valve body 16 is pressed from above by a nozzle ground (pressing metal member not) not shown in the drawing so as to fix the fuel injection nozzle body 16 to a cylinder head. An O-shaped ring 16b is inserted in the space between the injection valve body 16 and the cylinder head 110.

Further, a nozzle nut 3 in a shape of a sleeve supports the nozzle 1 and the spacer 15 inside thereof. The top part of the nozzle nut 3 is fixed to the injection valve body 16 on an outer circumference of the valve body 16 by screws (screw fastening sections 3a). A metal gasket 7 is inserted in the space under the bottom surface of the nozzle nut 3 to be attached to the nozzle nut 3.

Furthermore, an outer sleeve 6 is installed around the nozzle nut 3 such as to cover the outer circumference of the nozzle nut 3 like a sleeve so that a bottom surface 6c of the sleeve 6 touches the cylinder head 110.

In this manner, the nozzle nut 3 is fastened at the screw fastening sections 3a of the injection valve body 16 so that a shoulder part 1b of the nozzle 1 is secured between the nozzle nut 3 and the spacer 15.

Further, the metal gasket 7 for heat conduction is inserted between an outer bottom surface 3b of the nozzle nut 3 and a top surface 6b of the outer sleeve 6 facing the bottom surface 3b. The metal gasket 7 for fastening the injection valve body 16 to the cylinder head 110 is attached tightly between the outer bottom surface 3b of the nozzle nut 3 and the top surface 6b of the outer sleeve 6.

The top part of the outer sleeve 6 is fit into an inner part of the cylinder head 110, and the joint between the outer sleeve 6 and the cylinder head 110 is shaft-sealed and a shaft with an O-ring 11.

To perform the fuel injection, the fuel is passed through the fuel passage 21 and stored in the fuel storage 5, and once the pressure in the fuel storage 5 becomes higher than the downward force of the spring 9, the needle valve 2 opens so that the high-pressure fuel stored in the fuel storage 5 is injected through the injection holes 4.

In the fuel injection valve 100, the temperature of the seating portion 5a of the nozzle 1 rises in response to the high load operation of the engine. To sustain the durability of the nozzle 1, it is necessary to keep the temperature of the seating portion 5a below a certain temperature. However, the fuel injection valve 100 shown in FIG. 4 has limited capability to suppress the temperature rise.

The injection valves to take measure against the temperature rise of the nozzle are disclosed in Patent Document 1 (JP2001-221123A) and Patent Document 2 (JP2001-41131A).

According to Patent Document 1, the cylinder head has a joint hole into which heat transfer member is fitted and the nozzle is tightly fitted in a through-hole of the heat transfer member so as to transfer the heat firmly from the nozzle to the cylinder heat via the heat transfer member.

According to Patent Document 2, an o-ring of rubber type is disposed on inner and outer circumferences of the top part of the outer sleeve which surrounds the nozzle nut so as to prevent the water getting in from the top part of the outer sleeve.

As described above, it is necessary in the fuel injection valve to cool the nozzle whose temperature rises in response to the high load operation of the engine.

In such a case that the nozzle is not directly cooled by cooling media such as cooling water, it is necessary to effectively transfer heat from the nozzle to the cylinder heat.

In the fuel injection valve shown in FIG. 4, the heat is transferred from the nozzle 1 to the cylinder head 110 via the outer bottom surface 3b of the nozzle nut 3, the metal gasket 7 for heat transfer and the bottom part of the outer sleeve 6.

In this case, small gap A must be provided between the outer surface of the nozzle nut 3 and the inner surface of the outer sleeve 6 so as to provide a space for assembling and disassembling of the fuel injection valve and absorbing heat expansion of the components such as the injection valve body 16 and the nozzle nut 3. Thus, the small gap A cannot be utilized as a heat transfer surface.

Therefore, the fuel injection valve 100 has limited capability of suppressing the temperature rise of the nozzle in response to the high load operation of the engine and there is not enough cooling effect of the nozzle.

### RELATED ART DOCUMENT

### Patent Document

[PATENT DOCUMENT 1] JP2001-221123A

[PATENT DOCUMENT 2] JP2001-41131A

### SUMMARY OF THE INVENTION

In view of the problems of the related art, an object of the present invention is to provide a cooling structure of a fuel injection valve which can cope with the high load operation of the engine by transferring heat efficiently from a nozzle to a cylinder head and improving the cooling effect of the fuel injection valve including the nozzle.

To achieve the object of the present invention, the present invention proposes a cooling structure of a fuel injection valve which comprises: a nozzle having an injection hole at a tip; a nozzle nut being formed in a shape of sleeve and supporting the nozzle in an inner circumference of the nozzle nut; an outer sleeve surrounding an outer circumference of the nozzle nut and abutting a cylinder head at a bottom surface thereof; a metal gasket interposed between a bottom surface of the nozzle nut and an opposing surface of the outer sleeve; an injection valve body being fastened to the cylinder head, the nozzle being fixed to the nozzle nut by the injection valve body, a bottom surface of the outer sleeve being fixed to the cylinder head by a fastening force of the injection valve body to the cylinder head; and a needle valve being reciprocatably fit inside the nozzle and being removably attached to a seating portion of the nozzle at a tip so as to control an opening and closing of the needle valve to inject the fuel from the injection hole, the cooling structure of the injection valve comprising a metal ring member which is interposed between an outer circumferential face of the nozzle nut and an inner circumferential face of the outer sleeve so as to transfer heat from the nozzle to the cylinder head via the nozzle nut and the outer sleeve. In this, the metal ring member may be formed into a ring shape with a notched portion in an outer circumference thereof like a piston ring or a complete circle by configuring the nozzle nut to be capable of being separated and assembled so that the metal ring member can be fit in to be installed to the nozzle nut.

It is preferable to install the metal ring member in such a position that the outer circumferential face of the outer sleeve is in contact with a cooling water passage of a side of the cylinder head and the metal ring member is disposed in a space of a cylindrical slit shape in vicinity to the nozzle. However, there is some restriction to the installation location depending on the shape of the outer circumferential face of the nozzle nut and the inner circumferential face of the outer sleeve 6. For instance, the metal ring member cannot be installed where the circumferential surfaces form a taper shape. Therefore, it is preferable to install the metal ring member 10 in a space A of a cylindrical slit shape that is arranged lower than a spacer 15 interposed between the injection valve body and the nozzle.

Moreover, the space A extends from the outer circumference of the metal gasket 7 up to the top of the nozzle nut except for the section where the outer circumferential face of the nozzle nut tapers. As mentioned above, the metal ring member 10 may be installed in the space below the spacer 15.

In the example illustrated in FIG. 1, the nozzle nut 3 is not in direct contact with the spacer 15 and the injection valve body 16 is fit into the upper part of the nozzle nut 3 at a screw mounting section 3a to be installed between the injection valve body 16 and the nozzle 1. Therefore, it is efficient to install the metal ring member 10 in the space A of a slit shape that is arranged lower than the spacer 15 so as to efficiently cool the nozzle 1.

Moreover, the metal gasket 7 can be any metal with heat conductivity such as stainless steel and more preferably copper.

Further, it is preferable that the heat is transferred from the nozzle to the cylinder head via both of the metal gasket and the metal ring member.

Furthermore, a detailed cooling structure of the fuel injection valve is described below.
1) The metal ring member has a shape of a hollow ring, and the metal ring member is in contact with the inner circumferential face of the outer sleeve at an outer circumference thereof and with a groove formed in the outer circumferential face of the nozzle nut at an inner circumference thereof.
2) A spring is provided to press an outer circumference of the metal ring member against the inner circumferential face of the outer sleeve, the outer circumference of the metal ring member forming a contact face with the inner circumference face of the outer sleeve.

According to the present invention, in the fuel injection valve comprising the metal gasket interposed between the bottom surface of the nozzle nut and the opposing surface of the outer sleeve and the injection valve body being fastened to the cylinder head, by which the nozzle is fixed to the nozzle nut, the metal ring member is interposed between the outer circumferential face of the nozzle nut and the inner circumferential face of the outer sleeve so as to transfer heat from the nozzle to the cylinder head via the nozzle nut and the outer sleeve.

Therefore, the heat can be transferred from the nozzle to the cylinder head by the metal gasket via the bottom surfaces of the nozzle nut and the outer sleeve, and also by the metal ring member via the outer circumferential face of the nozzle nut and the inner circumferential face of the outer sleeve. In this manner, the heat can be transferred from the nozzle to the cylinder via both of the metal gasket and the metal ring member.

Also it is now possible to use the space between the outer circumferential face of the nozzle nut and the inner circumferential face of the outer sleeve which could not be used in the conventional case. By inserting the metal ring member lin the space between the outer circumferential face of the nozzle nut and the inner circumferential face of the outer sleeve, the faces can be utilized as heat transfer surfaces and the heat can be transferred from the nozzle to the cylinder head.

As described above, the heat is transferred from the nozzle to the cylinder head via both the metal gasket and the metal ring member so that in comparison to the conventional fuel injection valve of FIG. 3, a greater temperature drop can be expected and the nozzle can be operated at temperature not higher than the maximum allowable temperature even in the high load operation of the engine and thus the fuel injection valve that can cope with the high load operation of the engine can be obtained.

Further, unlike a fuel injection valve of a liquid cooling type which performs the cooling of the fuel injection valve by fuel oil or lubricant oil, no complex device such as a cooling passage is needed and the cooling performance of the fuel injection valve is improved at a low cost.

Furthermore, as a detailed cooling structure of the fuel injection valve, the metal ring member is formed into a ring shape with a hollow space inside such that the outer circumferential face thereof is in contact with the inner circumferential face of the outer sleeve and the inner circumferential face thereof is in contact with the groove arranged in the inner circumferential face of the nozzle nut. With this structure, by changing the shape of the metal ring member, the optimal contact pressure of the inner circumferential face and the outer circumferential face of the ring member can be obtained to transfer heat from the nozzle efficiently.

Moreover, as another detailed cooling structure of the fuel injection valve, the metal ring member comprises the spring which presses an outer circumference of the metal ring member against the inner circumferential face of the outer sleeve, and the outer circumference of the metal ring member forms the contact face with the inner circumference face of the outer sleeve. With this structure, by adjusting the strength of the spring which presses the contact face of the metal ring member, the optimal contact pressure can be obtained so as to transfer the heat efficiently from the nozzle 1 to the cylinder head side.

### BRIEF DESCRIPTION OF THE DRAWINGS

FIG. 1A sectional view of a main part of a fuel injection valve of a diesel engine in relation to a first preferred embodiment of the present invention.

FIG. 2 An enlarged view of a section Z of the first preferred embodiment.

FIG. 3 An enlarged view of a section Z of a second preferred embodiment.

FIG. 4 A sectional view of a main part of a fuel injection valve of a diesel engine in relation to the conventional case.

### DETAILED DESCRIPTION OF THE PREFERRED EMBODIMENTS

A preferred embodiment of the present invention will now be described in detail with reference to the accompanying drawings. It is intended, however, that unless particularly specified, dimensions, materials, shape, its relative positions and the like shall be interpreted as illustrative only and not limitative of the scope of the present.

### First Preferred Embodiment

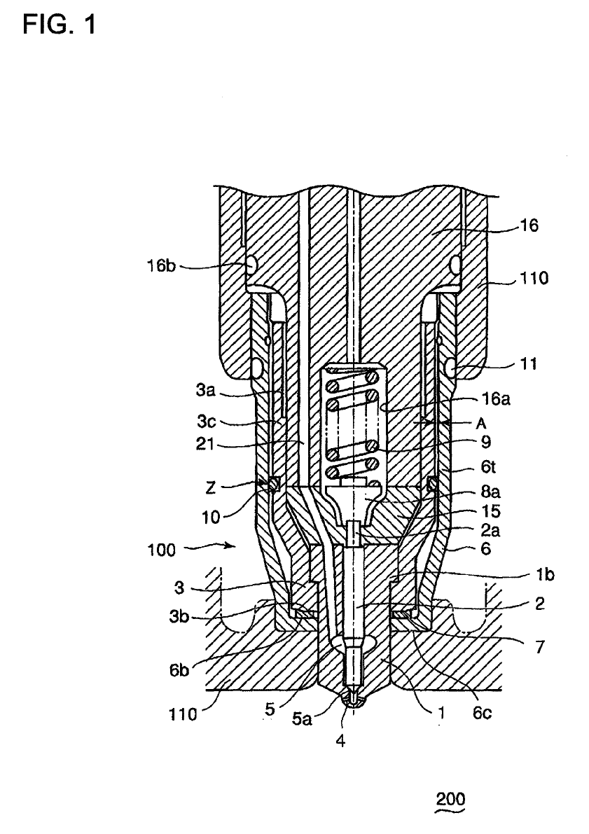

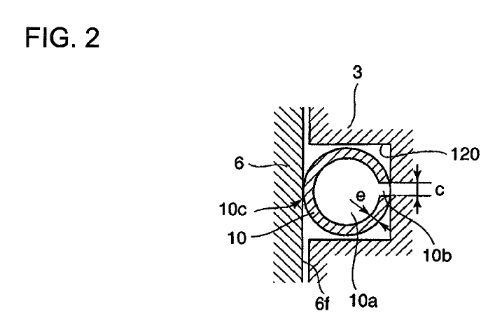

FIG. 1 is a sectional view of a main part of a fuel injection valve of a diesel engine in relation to a first preferred embodiment of the present invention. FIG. 2 is an enlarged view of a section Z of the first preferred embodiment.

FIG. 1 shows a fuel injection valve 100 in which a nozzle has an injection hole 4 for injecting fuel at a tip thereof and a needle valve 2 is fit in the nozzle 1 such that the needle valve can reciprocate therein. When there is no injection, the tip of the needle valve 2 is in contact with a seating portion 5a of the nozzle 1 so as to store high-pressure fuel in a fuel storage 5.

A fuel injection valve body 16 includes a hollow space 16a, and a spring shoe 8a of the nozzle valve is fit in the hollow space 16a at a bottom thereof in such a manner that the spring shoe 8a is in contact with a top end 2a of the needle valve 2.

Further, a needle valve spring 9 is interposed in the hollow space 16a between the spring shoe 8a and the injection valve body 16. In the non-injection state, the needle valve spring 9 presses the tip of the needle valve 2 against the seating portion 5a of the nozzle 1.

Furthermore, a spacer 15 is interposed between the injection valve body 16 and the nozzle 1. The needle valve 2 is inserted into the spacer 15. A fuel passage 21 is in connective communication with the fuel storage 5 through the injection valve body 16, the spacer 15 and the nozzle 1.

The top of the injection valve body 16 is pressed from above by a nozzle ground (pressing metal member) which is not shown in the drawing, so as to fix the fuel injection nozzle body 16 to a cylinder head. An O-shaped ring 16b is inserted in the space between the injection valve body 16 and a cylinder head 110.

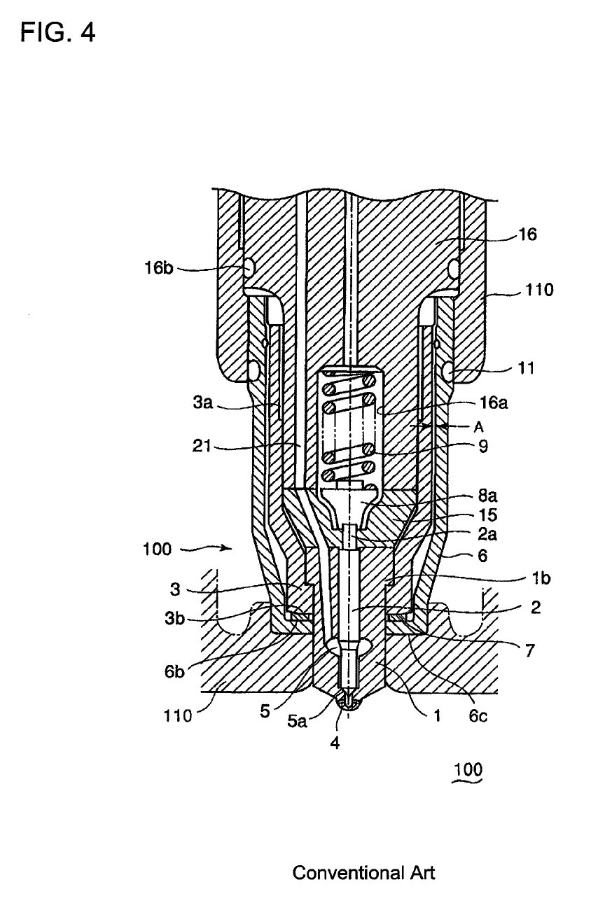

The configuration listed above is the same as the conventional case illustrated in FIG. 4.

In the fuel injection unit 100, a nozzle nut 3 is formed in a shape of sleeve and supporting the nozzle 1 and the spacer 15 in an inner circumference thereof. The top part of the nozzle nut 3 is fixed to the injection valve body 16 on an outer circumference of the valve body 16 by screws (screw fastening sections 3a).

Furthermore, an outer sleeve 6 is installed around the nozzle nut 3 such that the outer sleeve 6 surrounds the outer circumference of the nozzle nut 3 like a sleeve, and a bottom surface 6c thereof touches the cylinder head 110.

In this manner, the nozzle nut 3 is fastened at the screw fastening sections 3a of the injection valve body 16 so that a shoulder part 1b of the nozzle 1 is secured between the nozzle nut 3 and the spacer 15.

Further, a metal gasket 7 for heat conduction is inserted between an outer bottom surface 3b of the nozzle nut 3 and a top surface 6b of the outer sleeve 6 facing the bottom surface 3b. By fitting the injection valve body 16 in the nozzle nut 3 at the screw fastening section 3a, the metal gasket 7 is attached tightly between the outer bottom surface 3b of the nozzle nut 3 and the top surface 6b of the outer sleeve 6. The metal gasket 7 may be any metal with heat conductivity.

A metal ring member 10 is interposed between an outer circumferential face 3c of the nozzle nut 3 and an inner circumferential face 6t of the outer sleeve 6 so as to transfer heat from the nozzle 1 to the cylinder head 110 via the nozzle nut 3 and the outer sleeve 6.

Moreover, a small gap A is provided between the outer circumferential face 3c of the nozzle nut 3 and the inner circumferential face 6t of the outer sleeve 6 in the same manner as the conventional case so as to provide a space for assembling and disassembling the fuel injection valve 100 and for absorbing heat expansion of the components such as the fuel injection valve body 16 and the nozzle nut 3. Therefore, the outer circumferential face 3c and the outer circumferential face 6t can be utilized as heat transfer surfaces by providing the metal ring member 10.

In the first preferred embodiment, as illustrated in FIG. 2, the metal ring member 10 is inserted in a groove 120 and has a shape of a hollow ring with a hollow space 10a, and the metal ring member 10 is in contact with an inner circumferential face 6f of the outer sleeve 6 at an outer circumference 10c thereof and with the groove 120 formed in the outer circumferential face of the nozzle nut 3 at an inner circumference thereof. On the inner circumferential face, a communication path 10b having a opening width C is provided to open the hollow space 10a to outside.

In this manner, the heat can be transferred from the nozzle 1 to the cylinder head 110 via the metal ring member 10 with a hollow space. Further, by changing the shape of the metal ring member, the optimal contact pressure of the inner circumferential face and the outer circumferential face of the ring member 10 can be obtained to transfer the heat from the nozzle efficiently. Furthermore, by adjusting the opening width C of the communication path 10b, the contact pressure can be adjusted.

Moreover, the metal ring member 10 can be any metal with heat conductivity.

The top part of the outer sleeve 6 is fit into an inner part of the cylinder head 110, and the joint between the outer sleeve 6 and the cylinder head 110 is shaft-sealed and a shaft with an O-ring 11.

To perform the fuel injection, the fuel is passed through the fuel passage 21 and stored in the fuel storage 5, and once the pressure in the fuel storage 5 becomes higher than the downward force of the needle valve spring 9, the needle valve 2 opens so that the high-pressure fuel stored in the fuel storage 5 is injected through the injection hole 4.

According to the first preferred embodiment, the injection valve 100 comprises the metal gasket 7 interposed between the bottom surface of the nozzle nut 3 and the opposing surface of the outer sleeve 6, and the fuel injection valve body 16 being fastened to the cylinder head 110, and the nozzle 1 is fixed to the nozzle nut 3 by the injection valve body 16. Further, the metal ring member 10 is provided between the outer circumferential face 3c of the nozzle nut 3 and the inner circumferential face 6t of the outer sleeve 6 so as to transfer heat from the nozzle 1 to the cylinder head 110 via the nozzle nut 3 and the outer sleeve 6.

With the above structure, the heat can be transferred from the nozzle 1 to the cylinder head 110 by the metal gasket 7 via the nozzle nut 3 and the bottom surface of the outer sleeve 6. Furthermore, the heat can also be transferred from the nozzle 1 to the cylinder head 10 by the metal ring member 10 arranged between the outer circumferential face of the nozzle nut 3 and the inner circumferential face of the outer sleeve 6. Therefore, the heat can be transferred from the nozzle to the cylinder heat at two places, i.e. the metal gasket 7 and the metal ring member 10. Also it is now possible to use the space between the outer circumferential face of the nozzle nut 3 and the inner circumferential face of the outer sleeve 6 (the gap A) which could not be used in the conventional case. By inserting the metal ring member 10 in the space between the outer circumferential face of the nozzle nut 3 and the inner circumferential face of the outer sleeve 6, the faces can be utilized as heat transfer surfaces and the heat can be transferred from the nozzle 1 to the cylinder head 110.

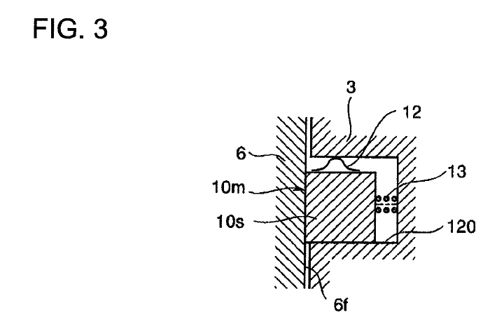

As described above, by transferring the heat from the nozzle 1 to the cylinder head 110 at two places, i.e. the metal gasket 7 and the metal ring member 10a, a greater temperature drop can be expected in comparison to the conventional injection valve of FIG. 3. Further, the nozzle 1 can be operated at temperature not higher than the maximum allowable temperature even in the high load operation of the engine and thus the fuel injection valve 100 that can cope with the high load operation of the engine can be obtained.

### Second Preferred Embodiment

A second preferred embodiment of the present invention is different from FIG. 1 in the configuration of the metal ring member.

FIG. 3 is an enlarged view of a section Z of a second preferred embodiment.

In FIG. 3, a metal ring member 10s is formed into a ring shape with a notched portion in an outer circumference thereof like a piston ring. The cross sectional shape of the metal ring member 10s is square. The metal ring member 10s is inserted in the groove 120 such that the outer part thereof touches the inner circumferential face 6f of the outer sleeve 6 to form a contact face 10m.

Furthermore, a spring 13 for pressing the contact face 10m against the inner circumferential face 6f of the outer sleeve 6 and another spring 12, e.g. a plate type spring for pressing the ring member 10s in the length direction thereof.

In this manner, by adjusting the strength of the springs 12 and 13 which press the contact face 10m of the metal ring member 10s, the optimal contact pressure can be obtained so as to transfer the heat efficiently from the nozzle 1 to the cylinder head 110 side.

Moreover, the metal ring member 10s can be any metal with heat conductivity.

### INDUSTRIAL APPLICABILITY

According to the present invention, the heat can be efficiently transferred from the nozzle to the cylinder head. By this, the cooling effect of the fuel injection valve including the nozzle can be improved and thus the cooling structure of the fuel injection valve to cope with the high load and high rotation of the engine can be provided.

1. A cooling structure of a fuel injection valve which comprises: a nozzle having an injection hole at a tip; a nozzle nut being formed in a shape of sleeve and supporting the nozzle in an inner circumference of the nozzle nut; an outer sleeve surrounding an outer circumference of the nozzle nut and abutting a cylinder head at a bottom surface thereof; a metal gasket interposed between a bottom surface of the nozzle nut and an opposing surface of the outer sleeve; an injection valve body being fastened to the cylinder head, the nozzle being fixed to the nozzle nut by the injection valve body, a bottom surface of the outer sleeve being fixed to the cylinder head by a fastening force of the injection valve body to the cylinder head; and a needle valve being reciprocatably fit inside the nozzle and being removably attached to a seating portion of the nozzle at a tip so as to control an opening and closing of the needle valve to inject the fuel from the injection hole, the cooling structure of the injection valve comprising:
a metal ring member which is interposed between an outer circumferential face of the nozzle nut and an inner circumferential face of the outer sleeve so as to transfer heat from the nozzle to the cylinder head via the nozzle nut and the outer sleeve.

2. The cooling structure of the fuel injection valve according to claim 1, wherein the heat is transferred from the nozzle to the cylinder head via both of the metal gasket and the metal ring member.

3. The cooling structure of the fuel injection valve according to claim 1, wherein the metal ring member has a shape of a hollow ring, and the metal ring member is in contact with the inner circumferential face of the outer sleeve at an outer circumference thereof and with a groove formed in the outer circumferential face of the nozzle nut at an inner circumference thereof.

4. The cooling structure of the fuel injection valve according to claim 1, further comprising a spring which presses an outer circumference of the metal ring member against the inner circumferential face of the outer sleeve, the outer circumference of the metal ring member forming a contact face with the inner circumference face of the outer sleeve.

5. The cooling structure of the fuel injection valve according to claim 1, wherein the metal ring member is formed into a ring shape with a notched portion in an outer circumference thereof like a piston ring.

6. The cooling structure of the fuel injection valve according to claim 1, wherein the metal ring member is a complete circle and the nozzle nut is configured to be capable of being separated and assembled so that the metal ring member can be fit in to be installed to the nozzle nut.

7. The cooling structure of the fuel injection valve according to claim 1, wherein the metal ring member is installed in such a position that the outer circumferential face of the outer sleeve is in contact with a cooling water passage of a side of the cylinder head and the metal ring member is disposed in a space of a cylindrical slit shape in vicinity to the nozzle.

8. The cooling structure of the fuel injection valve according to claim 1, wherein the metal ring member is installed in a space of a cylindrical slit shape which is arranged lower than a spacer interposed between the injection valve body and the nozzle.
